(19) United States
(12) Patent Application Publication
(10) Pub. No.: US 2009/0055429 A1
(43) Pub. Date: Feb. 26, 2009

(54) METHOD AND SYSTEM FOR DATA COLLECTION

(75) Inventors: John S. Notarnicola, Chesapeake, VA (US); Matthew G. Franz, Norfolk, VA (US); Arnold J. Byrd, JR., Carrollton, VA (US); Steven A. Duquette, North Richland Hills, TX (US); Carole Snow, Norfolk, VA (US)

Correspondence Address: BUCHANAN, INGERSOLL & ROONEY PC, POST OFFICE BOX 1404, ALEXANDRIA, VA, 22313-1404, US

(73) Assignee: LOCKHEED MARTIN CORPORATION, Bethesda, MD (US)

(21) Appl. No.: 12/197,971

(22) Filed: Aug. 25, 2008

Related U.S. Application Data
(60) Provisional application No. 60/935,638, filed on Aug. 23, 2007.

(51) Int. Cl. G06F 17/30

(52) U.S. Cl. 707/102; 707/E17.005

(57) ABSTRACT

A system and method for collecting data are disclosed. The system generates tables in a database corresponding to source data selected for collection. Using a first program thread, the system receives source data from a data source and stores the source data in a data storage device. Using a second program thread executed substantially concurrent with the first thread, the system extracts the selected source data from the data storage device, and stores the selected source data in the corresponding tables of the database.

### CROSS-REFERENCE TO RELATED PATENT APPLICATIONS

This application claims the benefit of priority to U.S. Provisional Patent Application 60/935,638, filed on Aug. 23, 2007, the entire disclosure of which is hereby incorporated by reference into this specification.

### FIELD

The present disclosure relates generally to methods and systems for data collection.

### BACKGROUND

Data collection tools are used for displaying, analyzing and verifying test results. However, collecting data can be difficult in real-time experiments and other tests in which data is generated at a high rate and/or results in large data logs. Moreover, the great quantity of data collected in such tests can make analysis of the data a costly and time-consuming effort. For example, in tests performed in virtual warfare environments, data is produced that models the movements and interactions of thousands of independent entities. Following the test, the collected data is provided to an analyst who manually imports all the test data into a database. Analysis of the collected data and error detection can be performed before starting a subsequent test, which can add substantial delay and cost to a test program. Moreover, the time involved in analyzing the data can preclude providing feedback during the test.

### SUMMARY

Exemplary systems and methods disclosed herein can provide a flexible and robust solution for data collection and analysis during experimentation efforts by providing instantaneous feedback about the validity of an experimental run and analysis of the data. Additionally, exemplary embodiments can reduce or eliminate the need for any post-test gathering and processing of data.

Exemplary data collection systems disclosed herein include, among other features: a computer having a processor and a computer-readable medium coupled to the processor; and a program stored in the computer-readable medium, the program, when executed by the processor, operable to: generate a plurality of tables in a database, the tables corresponding to source data selected for collection; store, using a first program thread, source data received from a data source in a data storage device; extract, using a second program thread executed substantially concurrent with the first thread, the selected source data from the data storage device; and store the selected source data in the corresponding tables of the database.

Exemplary data collection methods disclosed herein include, among other features, generating a plurality of tables in a database corresponding to source data selected for collection; storing, using a first program thread, source data received from a data source in a data storage device; extracting, using a second program thread executed substantially concurrent with the first thread, the selected source data from the data storage device; and storing the selected source data in the corresponding tables of the database.

### BRIEF DESCRIPTION OF THE DRAWINGS

FIG. 1 is a block diagram illustrating an exemplary system as disclosed herein;

FIG. 2 is a flow diagram illustrating an exemplary method as disclosed herein;

FIG. 3 is a flow diagram illustrating another exemplary method as disclosed herein;

FIG. 4 is an exemplary timing sequence diagram consistent with embodiments disclosed herein; and

FIGS. 5-11 are exemplary data structures consistent with embodiments disclosed herein.

### DETAILED DESCRIPTION

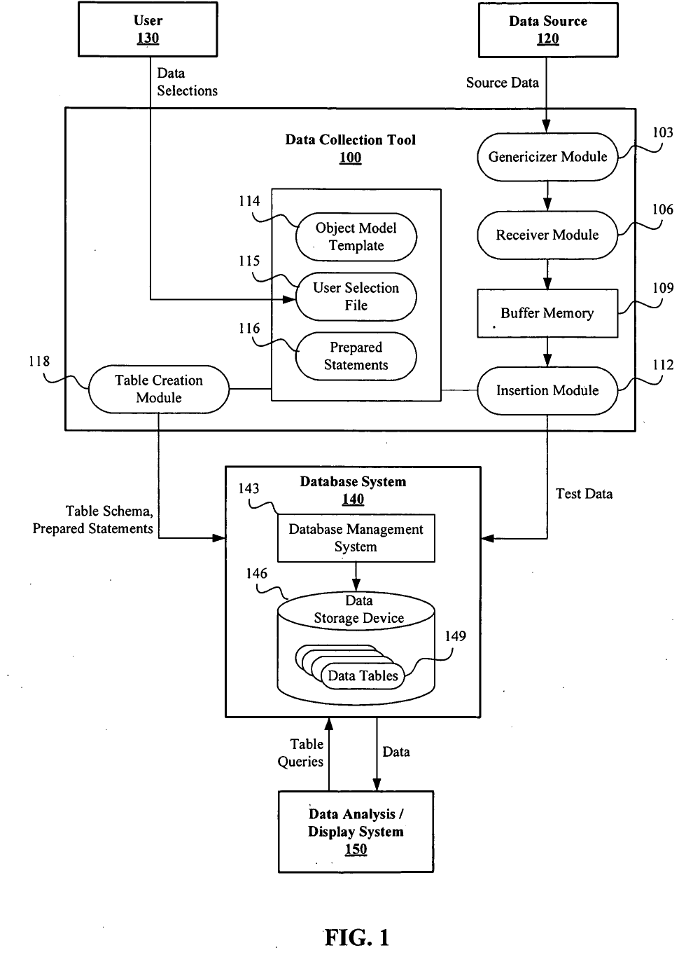

FIG. 1 is a block diagram illustrating an exemplary data collection tool 100. Exemplary data collection tool 100 can include a processor, and a computer-readable medium coupled to (e.g., contained within) the processor (not shown). A program stored in the computer-readable medium, when executed by the processor can generate a plurality of tables in a database corresponding to source data selected for collection; store, using a first program thread, source data received from a data source in a data storage device; extract, using a second program thread executed substantially concurrent with the first thread, the selected source data from the data storage device; and store the selected source data in the corresponding tables of the database. The test data can be received and stored by data collection tool 100 substantially in real-time. Data tables 149 can be accessed from the database system 140 by a data analysis/display system 150.

Data collection tool 100 can be, for instance, a data processing system that receives data from a simulation test environment and stores some or all of the data in a relational database. However, any system that produces data, especially at a high-rate, can benefit from embodiments disclosed herein. For instance, data source 120 can be a manufacturing monitoring system or a vehicle telemetry system.

Data collection tool 100 can receive data from a user 130 and data source 120. Data source 120 can be one or more systems that provides data to the data collection tool 100. For instance, data source 120 can be a real-time or near real-time test environment, such as a man-in-the-loop simulation or a distributed simulation test environment. Real-time systems are generally considered to be ones that update information at substantially the same rate as they receive data. Real-time systems can also be those in which processing delays are substantially imperceptible to a person; for example, video presented at a rate of about thirty frames-per-second or faster.

Data source 120 can provide source data to data collection tool 100 in a generic format. That is, a format that complies with some predefined structure that is not specific to a particular computing platform or other system. As detailed below, for example, data received from data source 120 can comply with High-Level Architecture (“HLA”) requirements. Data source 120, on the other hand, can also be a data source that is non-generic.

Database system 140 can include a database management system 143 and a data storage device 146. Database management system 143 can be one or more computer programs that store, modify, query, and extract information from a database in data storage device 146. Exemplary databases include, without limitation, those managed by software available from Oracle Corp., and the like. Terminology used to describe the database management in exemplary embodiments of the database system will be recognized by those skilled in the art as having special applicability to database management.

Data storage device 146 can be associated with database management system 143 storing software and data consistent with the disclosed embodiments. As shown in FIG. 1, database system 140 can store a plurality of tables 149 created to store select data received from data collection tool 100.

User 130 can select the source data that is to be captured by data collection tool 100. User 130 can be any individual or other entity that determines which information should be collected and/or analyzed during a test by data collection tool 100. For instance, user 130 can be a test director and/or analyst that selects which data is necessary or desired to analyze and display a test scenario. Data selections can be made from a catalog of data corresponding to predetermined table models stored by the database system 140. Data selections can be stored in user selection file 115; for instance, as a separate data table that identifies which data will be recorded for a particular test. The predetermined table models can be created based on the template describing the structure of object model template 114. In the exemplary case where data source 120 is a simulation test environment, user 130 can select from a predefined catalog of data associated with tables in the database that can be queried to meet user 130's selections. In other cases, the data can be selected ad hoc, or both. Data collection tool 100 can build table schema from object model template 114 based on user 130 selections of data to be analyzed or displayed by data analysis/display system 150. The table schema can define the tables for holding the data that is collected, as well as the fields in each table, and/or the relationships between fields and tables.

Database system 140 can be queried by data analysis/display system 150 to provide high-rate (e.g., real-time) analysis or display of test data received from data collection tool 100. Data analysis/display system 150 can be one or more programs for analyzing and reporting data from a database; for instance, Business Intelligence Suite provided by Oracle Corp., Redwood City, Calif.

FIG. 1 illustrates an exemplary flow of data from data sources 120 through data collection tool 100, database system 140, and to data analysis/data display system 150. Source data is provided from data source 120 to data collection tool 100. In the case where data source 120 provides non-generic source data, data collection tool 100's genercizer module 103 can process the data and places it in a generic format before processing it in receiver module 106.

Receiver module 106 receives generic data and stores the data in a data storage device, such as buffer memory 109, which serves as a data buffer between receiver module 106 and insertion module 112. Insertion module 112 retrieves data corresponding to user 130's data selections from memory and stores the retrieved data in database system 140. Receiver module 106 and insertion module 112 can be independent programs that are processed concurrently by data collection tool 100. For instance, receiver module 106 and insertion module 112 can be program threads executed by data collection tool 100 that write and read, respectively, data to/from buffer memory at substantially the same time—that is, at or about the same time, in such a manner that the read and write threads do not interfere with one another. By executing insertion module 112 and receiver module 106 as concurrent program threads, test data can be inserted in tables 149 by insertion module 112 at the same rate as it is stored by receiver module 106. As such, data analysis/display system 150 can query the data tables in database management system 140 to analyze and/or display data in real-time while a test is ongoing.

In an exemplary embodiment, data collection tool 100 can be used in distributed simulation test environments that include many simulations that can correspond to data source 120. Simulation environments can include many constituent simulations having thousands of respective entities. Simulations can be run locally and/or distributed on a wide-area network. The entities can be object-oriented entity level simulations, such as infantrymen, vehicles, munitions, structures, and sensors, that interact individually in a simulated (a.k.a. “synthetic” or “virtual”) environment.

A simulation can follow a generic architecture, such as the High Level Architecture (HLA), which is a general-purpose architecture for distributed computer simulation systems. Using HLA, simulation systems can communicate with other simulation systems regardless of their respective computing platforms. The individual simulations can be organized as “federations,” which are collections of simulations that work together to constitute a combined simulation environment. Terminology used in this specification, such as “high level architecture” and “federations,” describe an exemplary simulation architecture and will be recognized by those skilled in the art as generally describing distributed simulation environments.

The High Level Architecture standard includes an object model template (OMT), such as object model template 114, that provides a common framework for the communication between High Level Architecture simulations by specifying what information is communicated and how it is documented. The High Level Architecture object model template includes a Federation Object Model (FOM) and Simulation Object Model (SOM). The Federation Object Model describes the shared objects, attributes and interactions for the whole federation. The Simulation Object Model describes the shared objects, attributes and interactions used for a single federate.

A collection of related data sent between simulations is referred to as an “object.” Events sent between simulations are referred to as “interactions.” Objects have attributes and interactions have parameters. Objects and interactions that are HLA-compliant are “generic” and can be processed directly by receiver module 106. Any source data provided by non-generic simulations or federations can be placed in a generic format by genericizer module 103 before being provided to receiver module 106.

Because HLA simulations comply with the definitions in the Simulation Object Model, tables 149 can be created in database system 140 by data collection tool 100 that correspond to some or all of the data defined in object model template 114. Tables 149 can be created in advance of a simulation test based on selections of data by user 130, for example, to be provided from the test simulation to the tables in database system 140 for analysis and display by data analysis/display system 150.

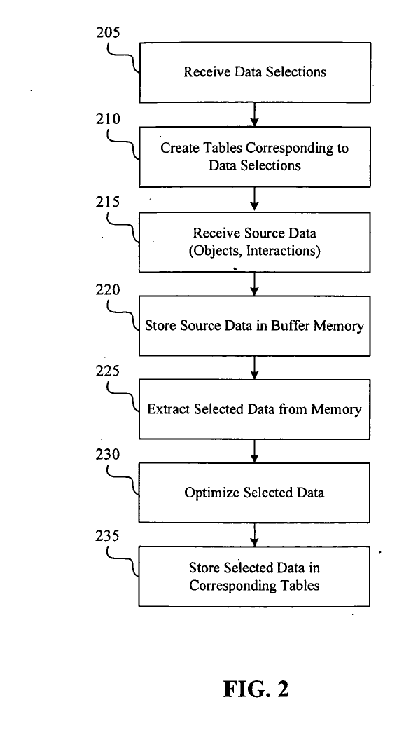

FIG. 2 illustrates an exemplary method for storing test data in database system 140. The method can include: generating tables 149 in data storage device 146 corresponding to select test data to be collected by data collection tool 100 during a test; storing, using receiver module 106, source data received from data source 120 into memory buffer 109; extracting, using insertion module 112 executed concurrently with receiver module 106, the selected test data from memory buffer 109; storing the selected test data in data storage device 146 in tables 149. Test data can be stored and extracted from data storage device 146 substantially in real-time. In addition, data analysis/display system 150 can retrieve selected test data from data storage device 146 to provide substantially real-time analysis or display based on the test data. The method can be implemented as instructions stored on computer-readable storage medium that, when executed by a processor, performs the steps of the method.

According to the method shown in FIG. 2, data collection tool 100 builds tables in database system 140. (Step 210.) Tables 149 can be built to store some or all of the source data provided by data source 120. For instance, where the data source 120 is a simulation test system, object model template 114 can define the types of data available. Because the data types are known in advance, the selections can be made from a predefined catalog of data, data types, and combinations thereof.

Data collection tool 100 receives source data, which is processed by receiver module 106. Receiver module 106 receives source data, for example simulation objects and interactions, from data source 120. Receiver module 106 can be a program thread that receives data from data source 120, formats the data, and stores the data in buffer memory 109. (Step 215.)

At substantially the same time, source data is stored in buffer memory 109 by receiver module 106, insertion module 112 extracts test data from buffer memory 109 and inserts the test data in corresponding data tables 149 of database system 140. (Step 225.) The insertion module 112 can be a program thread of the data collection tool 100 that regularly (e.g., constantly) polls the queue for available information and inserts the data into the database as it becomes available.

To prevent database system 140 from becoming a bottleneck, insertion module 112 can store test data in tables 149 at substantially the same rate as data collection tool 100 receives source data. When insertion module 112 retrieves a data unit from memory buffer 109, that data unit is packaged with header data. An exemplary data unit can include information such as: a time of the object or interaction update, an identification of the object or interaction, an identification of the attribute or parameter, a number of data columns in the table, and a list of information that needs to populate the database table.

Test data can be optimized for storage by insertion module 112 using information provided in a data unit. (Step 230.) Optimizing can take advantage of “prepared statements,” such as prepared statements 116, which are database instructions that are, for example, compiled and optimized by database management system 143 just once, as opposed to being processed every time a new insertion is made. Prepared statements 116 are useful, for instance, when one query of the database is being made with different parameters multiple times, such as a repeated entity position updates.

Prepared statements 116 can be generated by table creation module 118 for each of the data tables 149 that data collection tool 100 creates. Each prepared statement can be stored in a two-dimensional array, indexed first by the class or interaction number and then by the attribute or parameter number, as specified by the simulation object model. This arrangement gives insertion module 112 instant access to prepared statements 116, since the object or interaction and attribute or parameter is provided in the data unit. Using prepared statements also allows data collection tool 100 to take advantage of batch inserts. Batch inserts group multiple insert statements into a single set of data to be sent to the database system 140. When an insertion is made, data is communicated to database system 140, which responds to verify the insertion. By grouping insertions using batch inserts, the overhead associated with their transfer can be reduced, as can the number of times database system 140 need acknowledge receipt of the data reducing communication delays. Prepared statements also allow data collection tool 100 to update tables 149 in a binary format. This is advantageous since the data units retrieved by the insertion process already contain update information in a raw binary form.

Test data is stored in the corresponding tables 149 in database system 140. (Step 235.) Insertion module 112 can determine which data to retrieve from buffer memory 109 in more than one manner. For example, in some cases, insertion module 112 will retrieve and insert a set of data with a large backlog in buffer memory 109. In other cases, insertion module 112 will retrieve and insert data based on the time it has remained in buffer memory 109. Of course, other strategies for prioritizing the retrieval of data may be employed.

When an “insert query” of a known database system is sent to database management system 143, the information that is passed by the query when written to a record is referred to in database management terms as being “committed” to a data storage device. However, in exemplary embodiments disclosed herein, such information may not be written to a record (i.e., “committed”) in data storage device 146. Thus, while the data is stored in data storage device 146 immediately, it may not be available for analysis until it is committed. This commit is initiated by the data collection tool 100 application. Rather than committing each insert query as they are received by the database, batch commits are done incrementally. Each commit can take a significant amount of time and processing resources for the database management system 140 to perform, which can limit the amount of new data the system can receive. Committing hundreds of transactions at once reduces the overhead that is associated with insertions. Since substantially real-time data is desired to allow real-time analysis and display of test data, commits can be made whenever there is a sufficient backlog of transactions, whenever the data is several seconds old, and/or whenever the insertion module 112 has managed to empty buffer memory 109 quicker than the receiver module 106 can fill it. This procedure can ensure that test data can be committed at a real-time rate.

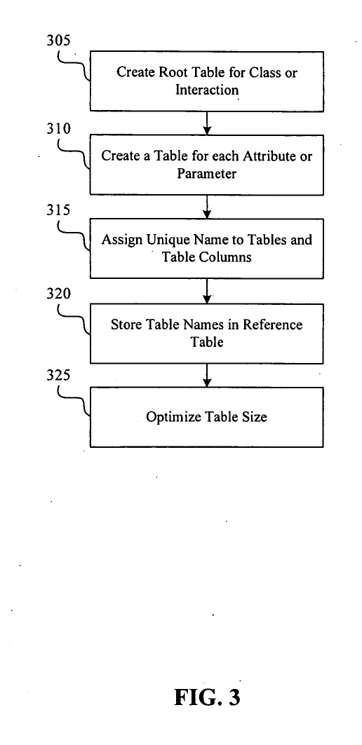

FIG. 3 is a flow diagram illustrating an exemplary process by which table creation module 118 creates table schema based on data selections. The process can include: creating a root table for objects and interactions; creating data tables 149 for attributes and parameters; assigning unique names to tables and table columns of tables 149; and storing data table names in a reference table. The method can also include optimizing sizes of the data table. Generally, in database system terms, a “schema” defines the structure and the type of contents that each data element within the table structure can contain. The schema is based on a predefined template that acts as a guideline for creating a relational database schema that reflects the data defined in an object model.

An object model, such as object model template 114, is a collection of objects or classes through which a program can interact with software or system. The object model provides a description of an object-oriented architecture, including the details of the object structure, interfaces between objects and other object-oriented features and functions. For instance, the Simulation Object Model's (SOM) Object Model Template (SOM). Data collection tool 100 can use object model template 114 as a guideline for creating a relational database schema that reflects the data defined in the simulation object model.

For example, tables 149 associated with a so-called “Platform” class, as defined in the Simulation Object Model, demonstrates how data collection tool 100 can generate a table schema from the information presented in the simulation object model. Although exemplified for the “Platform” class, the steps described pertain to the other classes and interactions in the simulation object model. Each class and interaction in the simulation object model is defined by its individual attributes and parameters. These attributes and parameters might be associated with a super-class or super-interaction. When the data collection tool 100 creates a table for a class or interaction it takes into consideration the corresponding attributes and parameters from both the immediate class/interaction and its associated super-class/super-interaction.

In creating a table schema, a root table is created for the objects or interactions included in object model template 114. (Step 305.) The root table represents the aggregate class whose relationships are associated to each one of its attributes or parameters. For example, the root table of the Platform class can hold an aggregation relationship (a ‘has a’ relationship) with each one of the attributes in object model template 114. Based on the relationships, each individual Platform object or interaction that is created in a simulation test environment can be identified.

A separate table is created in database system 140 for each attribute or parameter associated with the class or interaction. (Step 310.) Data collection tool 100 produces a “normalized database” that helps ensure data integrity and eliminates data redundancy within the individual database tables. For example, a database of Platform classes could contain information on an object's force, marking, appearance, and position. By normalizing the database, twenty position updates can be efficiently recorded into a single Platform-position table, rather than creating a separate table including redundant information for each attribute of these attributes of the Platform class.

Data collection tool 100 can produce a unique-naming schema for its tables and table columns. (Step 315.) The data collection tool 100's naming schema assures uniquely assigned table and column names in a manner described herein. For example, data collection tool 100 creates table names based on the following criteria: whether it is a class or interaction; class or interaction ID specified in the simulation object model; root, attribute or parameter table. Using the criteria specified above, data collection tool 100 table naming schema can conform to the following templates for class tables (e.g., root table, attribute table), and templates for interaction tables (e.g., root table, parameter table). The data collection tool 100 creates table column names based on fundamental data types that are owned directly by an attribute or parameter. This column naming schema can assure that column names are always unique within a table and at the same time portray some information about the data grouping.

For example, suppose that a table was being created for a complex attribute which consisted of: one fundamental type named A and one complex type named B. Assume that the complex data type B above consisted of: one fundamental type named A and one complex type named C. Further, assume the complex data type C is composed of the fundamental types X, Y, Z, and A. Lastly assume Z has a cardinality of 3. With all the information provided for the fictional attribute described above the data collection tool 100 would create the following data column names for the complex attribute table: [_A_{—}1], [_B_{—}2_A_{—}1], [_B_{—}2_C_{—}2_X_{—}1], [_B_{—}2_C_{—}2_Y_{—}2], [_B_{—}2_C_{—}2_Z_{—}3_{—}1], [_B_{—}2_C_{—}2_Z_{—}3_{—}2], [_B_{—}2_C_{—}2_Z_{—}3_{—}3], and [_B_{—}2_C_{—}2_A_{—}4].

The data collection tool 100 optimizes table space sizes by performing exact data type size matching. (Step. 325.) That is, data collection tool 100 uses the data type and cardinality information specified in the object model template to assign exact data type sizes to the table columns that it creates for attributes and interactions. This size matching procedure along with normalizing the database results in a database structure that minimizes the amount of space required in data storage device 146. In turn, this maximizes the amount of data that can be recorded in the database.

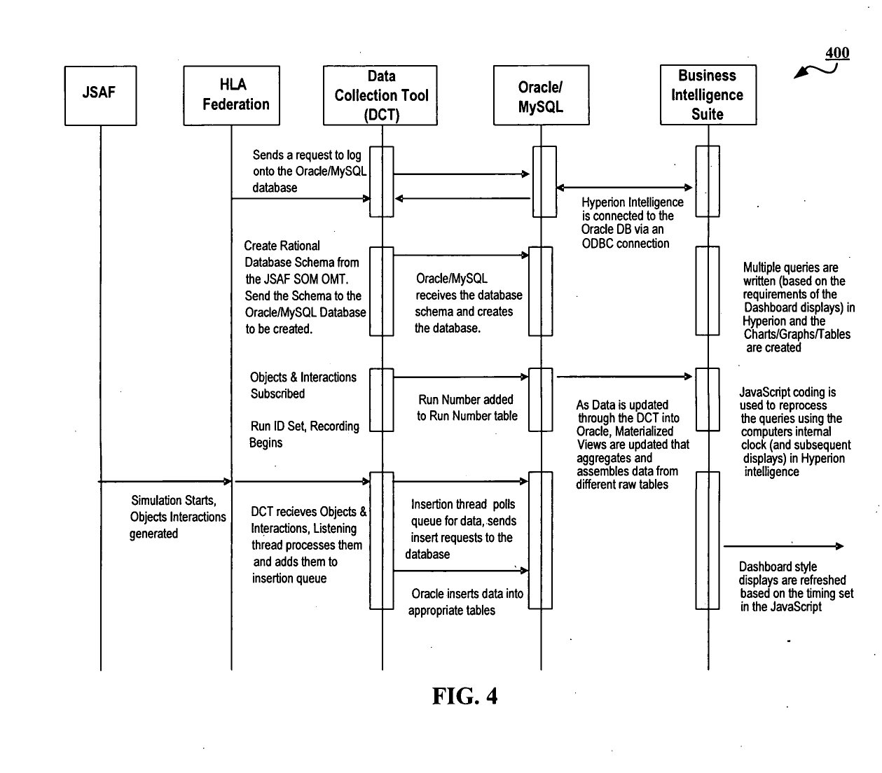

FIG. 4 shows a process-flow diagram of an exemplary implementation 400 consistent with some embodiments provided in this disclosure. In particular, the exemplary implementation illustrated FIG. 4 shows the information exchanged between data collection tool 100 in a distributed simulation exercise including a Joint Semi-Automated Force (JSAF) simulation linked through a HLA Federation. Data collection tool 100 stores the source data from the simulation exercise in a database system 140, such as an Oracle or MySQL database. The stored data can be used to analyze and display data by a data analysis/display system 150, such as Oracle's Business Intelligence Suite.

Data collection tool 100 directly records HLA traffic that exists in a HLA federation; indirectly records traffic received from distributed simulations (e.g., “Distributed Interactive Simulation” or “DIS”) by translating data into a HLA federation via an external gateway; and/or provides a generic database interface which allows the data collection tool 100 to record federation data into many different formats. As such, recording to both Oracle and MySQL databases can been implemented, for example.

The JSAF SOM defines what can be recorded by the data collection tool 100 and the user specifies which objects and interactions will be recorded. Data collection tool 100's relational database table creation module 118 can accommodate any existing or newly added class and interaction that exists inside of JSAF's Simulation Object Model (SOM).

Displayed in Table 1 below is an excerpt from the JSAF SOM Object Model Template (OMT). Data collection tool 100 uses this HLA-defined OMT format as a guideline for creating a relational database schema which reflects the data defined in the JSAF SOM.

TABLE 1

(Class (ID 9)

(Name “BaseEntity”)
(PSCapabilities S)
(Description “A base class of all scenario

domain participants, both aggregate and discrete.
The BaseEntity class is intended to be a container
for common attributes for entities of all classes. ”)

. . .
(Attribute (Name “position”)

(DataType

“gcs_world_coordinate64”)

(Cardinality “1”)

. . .

(Description “location of the

entity.”))

)
(Class (ID 30)

(Name “Platform”)
(PSCapabilities PS)
(Description “vehicles such as ships, tanks,

aircraft and submarines, (e.g., entities which are
moveable on Land, Air, Surface, Subsurface and
Space domains) .”)

(SuperClass 27)
(Attribute (Name “dis_entity_id”)

(DataType “DISEntityIdentifier”)
(Cardinality “1”)
. . .
(Description “The unique identifier

for the entity instance.”))

. . .

)

The following is an example of an executable process (i.e., a program) which can create the tables associated with the Platform class to illustrate how the data collection tool 100 generates a table schema from the information presented in the JSAF SOM. The steps taken are not limited to the Platform class, and can, for example, be configured to create the database schema for all other classes and interactions in the JSAF SOM.

Each class and interaction in the JSAF SOM is defined by its individual attributes and parameters. These attributes and parameters might be associated with a super-class or super-interaction. When data collection tool 100 creates tables, such as data tables 149, for a class or interaction it takes into consideration the corresponding attributes and parameters from both the immediate class/interaction and its associated super-class/super-interaction.

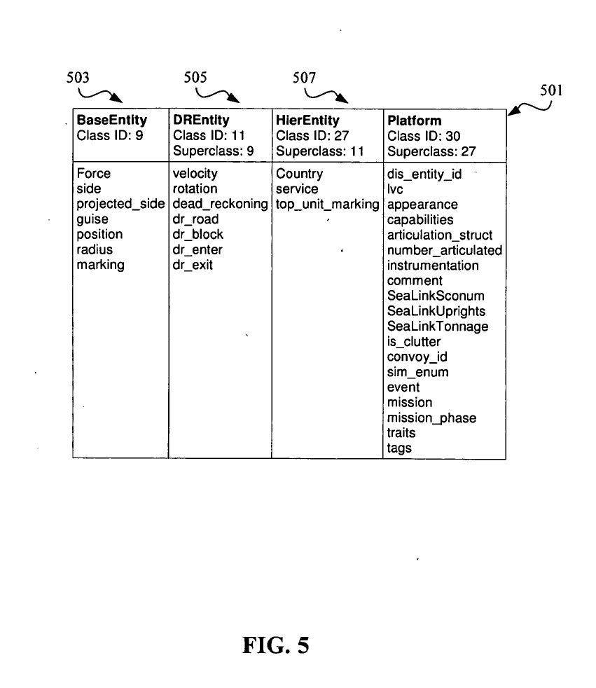

FIG. 5 shows the exemplary Platform class 501 and its associated super-classes 503-507. The procedure that data collection tool 100 goes through in order to create the tables for the Platform class is described below. The first step in creating a relational table schema for a class or interaction is to create a root table for that class or interaction. The root table represents the aggregate class whose aggregation relationships are associated to each one of its attributes or parameters. For example, a root table of a “Platform” 501 class can hold an aggregation relationship (a ‘has a’ relationship) with each one of the attributes shown in FIG. 5.

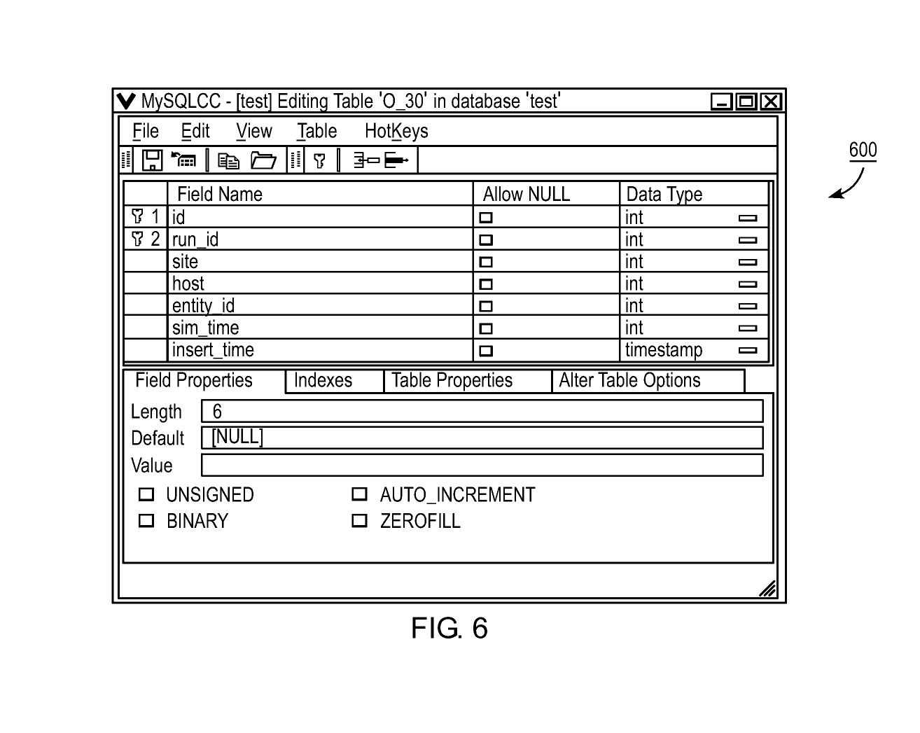

FIG. 6 displays the schema 600 created for the Platform class's root table. As shown, the Platform class's root table includes (e.g., consists of) the following columns:
id—Uniquely identifies each Platform class. The value is supplied by the Platform class being recorded;
run_id—Uniquely identifies each recording; site—Site ID of the data collection tool 100 application;
host—Application ID of the data collection tool 100 application;
entity_id—The data collection tool 100's internal representation (id) of the simulated Platform class;
sim_time—The time in milliseconds, starting from zero, since the recording began; and
insert_time—The time the Platform class was recorded into the root table. The time stamp belongs to the machine hosting the database.

FIG. 6 contains information for analyzing the simulation data. The <id, run_id> pair is the primary key for the Platform class's root table. This primary key can be used to identify each individual Platform object which is created during experiment runs. The <site, host, entity_id> triplet uniquely identifies simulation classes during a recording. The <site, host, entity_id> triplet can be used to map simulation events and states back to simulated classes. For example, a Fire interaction specifies a shooter, traceable to a specific Platform. The <shooter_site, shooter_host, shooter_entity_id> located in the Fire-shooter interaction table is compared to the <site, host, entity_id> located in the root Platform table. Using the same methods, the target Platform of a Fire interaction can be extracted from the simulation data.

Similar to classes, interactions recorded by the data collection tool 100 can have the <site, host, entity_id> triplet columns defined in their root tables. However, no values for these columns can be specified when interactions are inserted into the root table. This information is not relevant for interactions, since interactions occur only once and the information necessary to aggregate the parameters is contained in the <id, run_id> pair.

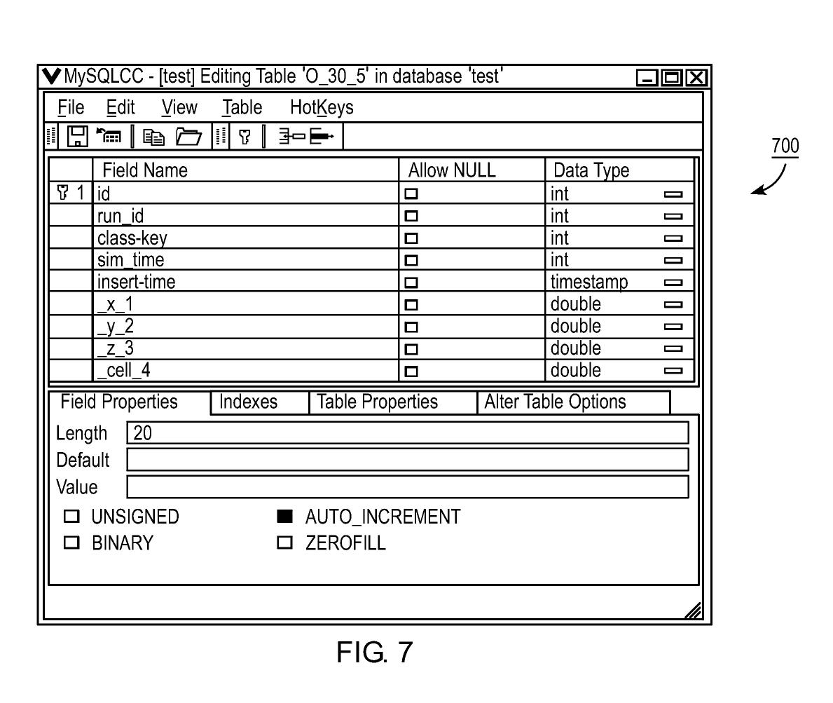

The second step in creating a relational table schema for a class or interaction is to create a separate table for each attribute or parameter that is associated with the class or interaction. FIG. 7 displays the Platform class's Platform-position table 700. The Platform-position table includes (e.g., consists of) the following core columns:
id—Primary key. Starts at 1 and increments by 1 for every position entry inserted into the table;
run_id—Identifies the recording that the position entry belongs to;
class_key—Links the position entry back to its related class. The root table aggregates the class information by matching its id field to this class key field;
sim_time—The time in milliseconds, starting from zero, since the recording began; and
insert_time—The time the position entry are inserted into the table. The time stamp belongs to the machine hosting the database.

In this example columns _x_{—}1, _y_{—}2, _z_{—}3, and _cell_{—}4 are added onto the core columns created for the Platform-position table. These additional columns represent the data for the Platform class's position attribute. These columns are defined by reducing the position attribute into its individual fundamental data types.

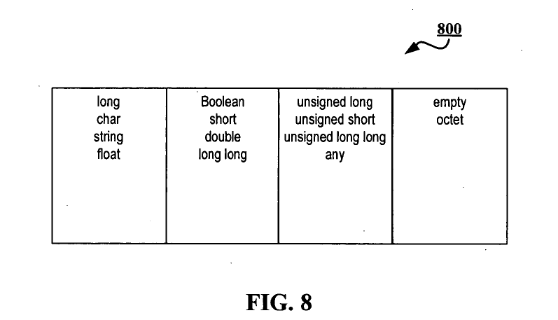

The JSAF SOM currently defines the listed data types 800 listed in FIG. 8 as being fundamental. With reference to Table 1, the data type for the position attribute is gcs_world_coordinate64, which is not a defined fundamental data type in FIG. 8, but rather a complex data type. A complex data type can be composed of, for example: one or many fundamental data types; one or many complex data types; and/or a combination of fundamental and complex data types. In this example gcs_world_coordinate64 is decomposed into its fundamental data types “double x, double y, double z, double cell” which are represented as “_x_{—}1, _y_{—}2, _z_{—}3, _cell_{—}4” respectively in the Platform position table. The addition of the underscores and numbers is explained in section 3.3.

FIG. 7 shows how the attribute tables, such as Platform-position table 700, can be used to analyze the simulation data of a specific object. The <run_id, class_key> pair is a foreign key which links back to the Platform root table. A foreign key serves as a constraint to associate a row of data in one table to a row of data in other tables. This foreign key is responsible for linking entries within the Platform-position table back to their class entry in the Platform root table.

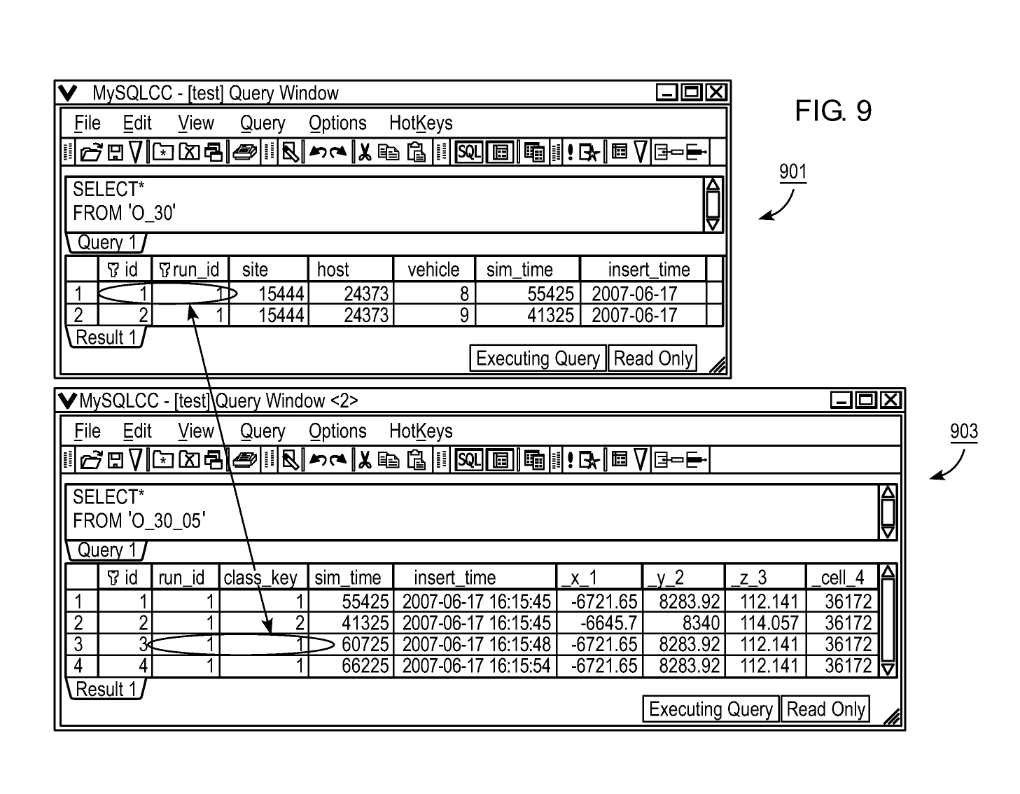

FIG. 9 shows the foreign key relationship that exists between the Platform root table 901 and the Platform-position table 903. FIG. 9 shows that the vehicle with <site, host, entity_id> equal to <15444, 24373, 9> can trace its position throughout a scenario run by matching the <id, run_id> pair in Platform root table 901 with the <class_key, run_id> pair in the Platform-position table. Although the <class_key, run_id> pair in Platform-position table 903 is used as a foreign key it is not specified as a foreign key in the database. This can speed up the insertion rate into the database. The increase in speed is due to the fact that the database does not need to make referential integrity checks as it is inserts data into the database.

Data collection tool 100's database schema ensures data integrity and eliminates data redundancy within the individual database tables. Eliminating redundancy enables data collection tool 100 to efficiently store data it gathers. A direct benefit of this can be that space is conserved in data storage device 146. Data collection tool 100 can record massive amounts of federation data for long periods. A 500 MB normalized data recording can easily become a 2 GB dataset if recorded in an un-normalized database structure. For example, a database of Platform classes could contain information on force, marking, appearance, and position. It is possible to create one massive table with a single row for every Platform series, and within that row store all of the Platform parameters along with the run_id, date/time, and insert time. However, this approach can be problematic when recording Platform position updates. For example, if a Platform class generates twenty position updates during a single scenario run; twenty position updates will be inserted into the Platform table. However, in addition to the twenty position updates, twenty identical force, marking, and appearance parameters will also be recorded for that entity.

In a normalized database the twenty position updates are recorded into a Platform-position table, thus eliminating any redundant data. This matches the way objects are updated in HLA, on an attribute by attribute basis, instead of resending the entire object with each update.

The data collection tool 100's naming schema can assure uniquely assigned table and column names. It can create table names based on criteria including: whether it is a class or interaction; class or interaction ID specified in the JSAF SOM; and root, attribute or parameter tables. Using the criteria above, the data collection tool 100 table naming schema can conform to the following templates defined below: Templates for class tables:

O_<class ID> (root table)

O_<class ID> _<attribute index> (attribute table)

Templates for interaction tables:

I_<interaction ID> (root table)

I_<interaction ID> _<parameter index> (parameter table)

While this table naming schema that the data collection tool 100 provides assures that table names are always unique it also portrays some information about the table's content. For example, the table name created for the Platform-position table was “O_{—}30_{—}05”. This table name tells the user that it holds information on the fifth attribute of a class in the JSAF SOM with a class ID equal to 30.

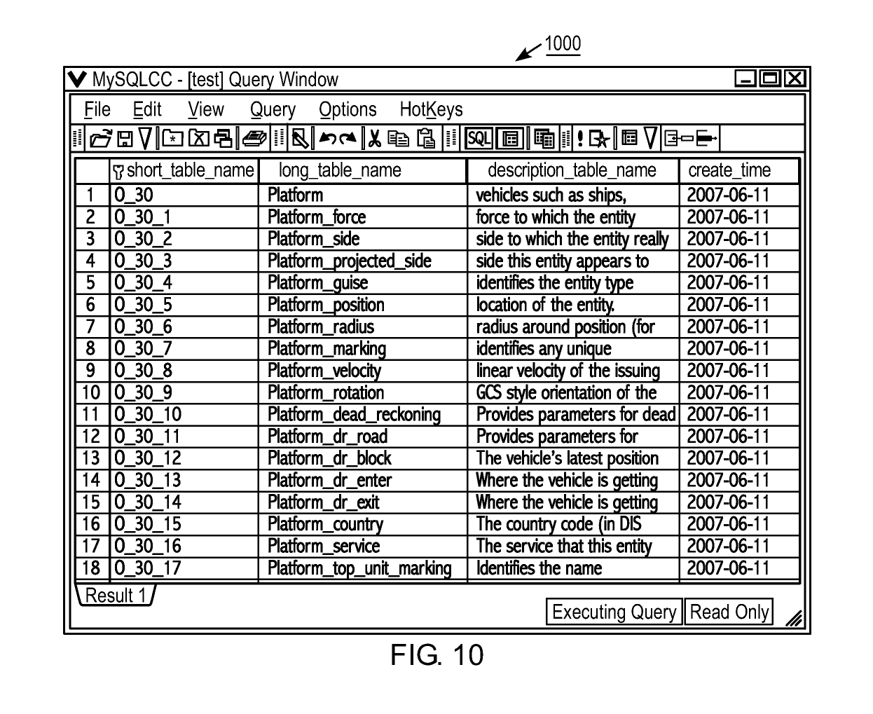

The data collection tool 100 can also provide more in depth information about the table created in a reference table called Long_Table_Name. FIG. 10 shows a screen shot of the Long_Table_Name table 1000 and all of the entries that were made while creating the database schema for the Platform class. This table holds information on the following:
short_table_name—The table name of the table that this entry belongs to. This field also acts as the primary key for the table.
long_table_name—A descriptive name for the table. For example, table O_{—}30_{—}05's long_table_name would be Platform-position.
description_table_name—Description of the table. This description is retrieved from the JSAF SOM.
create_time—The time the entry was made into the database. The time is retrieved from the machine hosting the database.

The table for an attribute or interaction is composed of a set of core columns, which exist for every attribute and parameter, and fundamental data columns, which are derived from the attribute or parameter as it is defined by the SOM.

Data collection tool 100 creates table column names based on the following criteria: a fundamental data type that is owned directly by an attribute or parameter takes the following syntax: _<data type name>; a fundamental data type that is owned by a complex data type takes the following syntax: <name derived thus far>_<data type name>; a complex data type that is owned directly by an attribute or parameter is broken down into its separate fundamental and complex data types.

The data types take the following syntax: _<data type name>_<data index>; A complex data type that is owned directly by another complex data type is broken down into its separate fundamental and complex data types which take the following syntax: <name derived thus far>_<data type name>_<data index>; A fundamental data type that is owned directly by an attribute or parameter data type and has a cardinality greater than one will generate the following syntax: _<data type name>_{—}1, . . . , _<data type name>_n; A fundamental data type that is owned by a complex data type and has a cardinality greater than one will generate the following syntax: <name derived thus far>_<data type name>_{—}1, . . . , <name derived thus far>_<data type name>_n. This column naming schema can assure that column names are always unique within a table and at the same time portray some information about the data grouping. For example, suppose that a table was being created for a complex attribute which consisted of: one fundamental type named A; one complex type named B.

Assume that the complex data type B above consisted of: one fundamental type named A; one complex type named C. Further, assume the complex data type C is composed of the fundamental types X, Y, Z, and A. Lastly assume Z has a cardinality of 3. With all the information provided for the fictional attribute described above the data collection tool 100 would create the following data column names for the complex attribute table: _A_{—}1; _B_{—}2_A_{—}1; _B_{—}2_C_{—}2_X_{—}1; _B_{—}2_C_{—}2_Y_{—}2; _B_{—}2_C_{—}2_Z_{—}3_{—}1; _B_{—}2_C_{—}2_Z_{—}3_{—}2; _B_{—}2_C_{—}2_Z_{—}3_{—}3; _B_{—}2_C_{—}2_A_{—}4

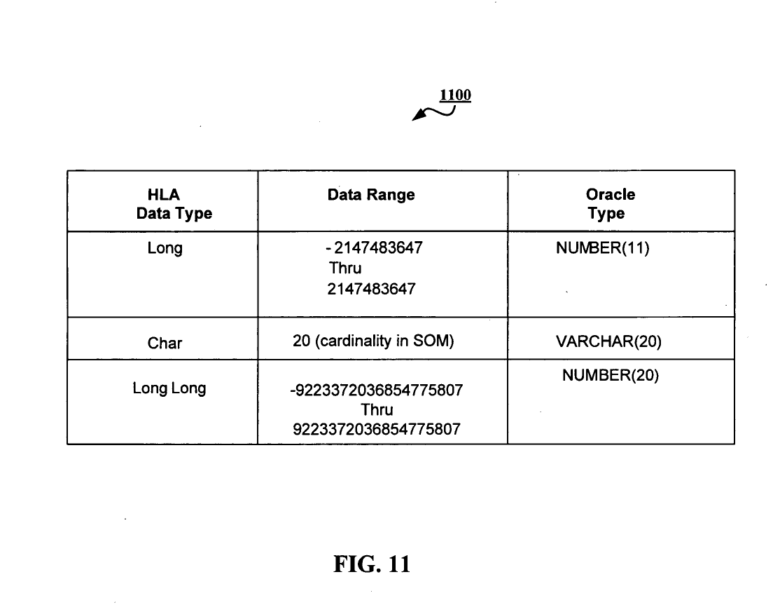

Data collection tool 100 can use the data type and cardinality information specified in the JSAF SOM OMT to assign exact data type sizes to the table columns that it creates for attributes and interactions. This size matching procedure along with normalizing the database results in a sleek database structure which can minimize the amount of disk space used by the database. This shrinking of space can, in turn, maximize the amount of data that can be recorded in the database. FIG. 11 shows a few examples of how JSAF data types 1100 defined in the SOM are mapped to equivalent Oracle data types.

It may be desirable that all federates maintain the integrity of their individual simulation roles in complex scenario environments. In order to maintain their integrity they need to be able to process all the information that they are subscribed to (the information pertinent to themselves). Fortunately, most federates are not subscribed to every bit of information that is contained in a HLA federation. Instead, federates are usually interested in a subset of the information and are able to ignore the remaining data packets. This selective listening of information decreases the data load that a federate has to process.

Rigorous experimentation analysis requires complete data sets for analysis. Experiment analysts may only be interested in a pre-defined subset of the simulation data defined by the SOM. The data collection tool 100 can record only the specified subset; however, it should ensure that it records the entirety of that subset. This puts a unique strain on a data logging federate, since dropping data is unacceptable. The data which is obtained through experimentation cannot be validated if there is a possibility that it is incomplete. To ensure the integrity of the captured information, the data collection tool 100 can split the recording process into two independent threads. The data collection tool 100 instantiates a listening thread and an insertion thread, which enables the data collection tool 100 to handle large volumes of data.

Receiver module 106 retrieves data from the Run-Time Infrastructure (RTI), formats the information, and places it in buffer memory 109 for processing. Insertion module 112 regularly (e.g., constantly) polls buffer memory 109 for available information and inserts the data into the database as it becomes available. If data collection tool 100 was not decoupled into receiver module 106 and insertion module 112, it could sequentially perform listening and insertion on each unit of data that it received from the RTI before retrieving the next unit of data. Doing so could hamper the recording speed of data collection tool 100 since the recording speed is limited to the amount of time it takes to listen and insert. In this situation it is possible for database insertions to become the bottleneck for the recording process, resulting in dropped data packets.

In a HLA federation each federate gives the RTI a time slice in which it can retrieve objects and interactions. The potential bottleneck created by the insertion process threatens the integrity of the coupled recording process since it potentially slows data collection tool 100's listening process. Consequently, the coupled recording makes it more likely that the data collection tool 100 will drop data units that it is not able to retrieve in its allotted time slice.

Creating independent listening and insertion threads maximizes the number of data units that data collection tool 100 is able to retrieve from the RTI. The data retrieval speed of the data collection tool 100 is only limited by how fast it can listen. The insertion of data was optimized using several different methods.

When the insertion process retrieves a data unit from the process queue, that data unit is packaged with header data. The data unit includes: simtime—simulation time of the object or interaction update; objIntNum—id of the object or interaction; attrParamNum—id of the attribute or parameter; numColumns—number of data columns in the database table; obj_int_data_list—list of information that needs to populate the database table.

Using the information provided in a data unit enables the data collection tool 100 to optimize its insertion process by taking advantage of Oracle's prepared statements. Prepared statements are desirable to use when one query is being made with different parameters multiple times, such as a repeated entity position update. It can be advantageous to use the prepared statement because it is compiled and optimized by the database just once versus being processed every time a new insertion is made. In a scenario where thousands of insertions are required every second, any amount of processing time that can be saved is important.

Prepared statements are generated for each class and interaction table that the data collection tool 100 creates. Each prepared statement is stored in a two-dimensional array, indexed first by the class or interaction number and then by the attribute or parameter number as specified by the JSAF SOM. This arrangement gives the data collection tool 100's insertion process instant access to the prepared statement, since the class or interaction number and attribute or parameter number is provided in the data unit.

Using prepared statements also allows the data collection tool 100 to take advantage of batch inserts. Batch inserts group multiple insert statements into a single set of data to be sent to the database. When an insertion is made to the Oracle database, the data packets must be sent to the database via a network connection. Additionally, Oracle can respond via the same network connection to verify the insertion. When these insertions can be grouped using batch inserts, the overhead associated with their transfer is reduced, as are the number of times Oracle acknowledges receipt of the data reducing network traffic. Additionally, batch inserts can take advantage of Oracle's inherent ability to perform more efficiently on large sets of identical statements.

Using Oracle's prepared statements also allows the data collection tool 100 to perform table updates in a binary format. This is advantageous since the data units retrieved by the insertion process already contain update information in a raw binary form. In contrast, the alternative method to inserting data into an Oracle database would be to inflate this binary data into an ASCII SQL statement which is then sent to the database for processing. Sending information in the form of an ACSII SQL string is processor intensive for an Oracle database since it will have to decode all the data retrieved back into its binary format before inserting it into the database. In addition to the degraded performance that strings initiate on the database they also prevent the data collection tool 100 from using prepared statements and taking advantage of the optimizations that it provides, such as batch inserts and query optimization.

When an insert query is sent to the database the information that is passed is not instantly committed into the database. While the data is stored in the database immediately, it will not be available for analysis until it is committed. This commit is initiated by the data collection tool 100 application. Rather than committing each insert query as they as received by the database, batch commits are done incrementally. Each commit can take a significant amount of time and processing resources for the Oracle database to perform, which limits the amount of new data the Oracle database can receive. Committing hundreds of transactions at once reduces the overhead which is associated with each individual transaction.

Since near real-time data is desirable for analysis, commits are made whenever there is a sufficient backlog of transactions, whenever the data is several seconds old, and/or whenever the insertion thread has managed to empty the queue quicker than the listening thread can fill it. This procedure ensures that data is committed in a timely fashion in order to satisfy the real-time goal.

Other design decisions make the data collection tool 100 a robust and durable tool for use during experimentation. The data collection tool 100 is capable of separating the HLA network from the database network via dual Network Interface Card (NIC) support. This means that the simulation network should not be flooded with the heavy traffic of Oracle transactions which are being performed. Additionally, the generic database table schema generation can ensure that no new development is required if any changes to the JSAF SOM occurs. Also, since the schema is built from the SOM at run time, this can reduce the burden on the operation analysts who otherwise would be forced to build the schema themselves. Since the same methods to format the data for insertion, the data collection tool 100 is guaranteed to parse and insert the data consistently.

Lastly, the generic database interface means that the data collection tool 100 can be used to insert data into any kind of database with little effort. Currently, the data collection tool 100 supports inserting into Oracle and MySQL databases.

The SOM implementation of the data collection tool 100 means that the data collection tool 100 can be geared towards recording experimentation data built around JSAF. Implementing a FOM based data collection tool 100 would allow for direct recording of other simulators, increasing the flexibility and possible uses of the data collection tool 100.

By extending the architecture to have multiple data collection tools listening for traffic and pushing data to a central location, larger scenarios could be supported. Each data collection tool could listen to data from a specific simulator, or listen for a particular object or interaction. This expansion would allow the data collection tool 100's capabilities to scale upward as experiment scenarios grow.

As disclosed herein, embodiments and features can be implemented through computer hardware and/or software. Such embodiments can be implemented in various environments, such as networked and computing-based environments with one or more users. Systems consistent with the present disclosure, however, are not limited to such examples, and embodiments can be implemented with other platforms and in other environments.

Moreover, while illustrative embodiments have been described herein, further embodiments can include equivalent elements, modifications, omissions, combinations (e.g., of aspects across various embodiments), adaptations and/or alterations as would be appreciated by those in the art based on the present disclosure.

Other embodiments consistent with this disclosure will be apparent to those skilled in the art from consideration of the specification and practice of the embodiments of the invention disclosed herein. Further, the steps of the disclosed methods can be modified, including inserting or deleting steps, without departing from the principles of the method. It is therefore intended that the specification and embodiments be considered as exemplary only.

What is claimed is:

1. A data collection system, comprising:
a computer having a processor and a computer-readable medium coupled to the processor; and
a program stored in the computer-readable medium, the program, when executed by the processor, operable to:
generate a plurality of tables in a database, the tables corresponding to source data selected for collection;
store, using a first program thread, source data received from a data source in a data storage device;
extract, using a second program thread executed substantially concurrent with the first thread, the selected source data from the data storage device; and
store the selected source data in the corresponding tables of the database.

2. The system of claim 1, wherein the source data received from a data source is stored and extracted in real-time.

3. The system of claim 1, wherein the source data received from a data source is structured in a generic format.

4. The system of claim 3, wherein the source data received from a data source is converted into the generic format.

5. The system of claim 1, wherein the program is operable to:
generate tables for the attributes and parameters in an object model template corresponding to the source data selected for collection.

6. The system of claim 5, wherein the program is operable to:
generate a root table based on the object model template, the root table being an aggregate class associating an object included in the object model template with attributes or parameters associated with the object.

7. The system of claim 5, wherein the program is operable to:
receive data selections from a user based on a catalog produced based on the object model template.

8. The system of claim 7, wherein the program is operable to:
assign unique names to the tables and columns based on the object model template.

9. The system of claim 6, the selected source data is stored based on prepared statements corresponding to the attributes and the parameters in the object model template.

10. The system of claim 8, wherein the selected source data is stored based on the prepared statements using batch inserts.

11. A data collection method, comprising:
generating a plurality of tables in a database, the tables corresponding to source data selected for collection;
storing, using a first program thread, source data received from a data source in a data storage device;
extracting, using a second program thread executed substantially concurrent with the first thread, the selected source data from the data storage device; and
storing the selected source data in the corresponding tables of the database.

12. The method of claim 11, wherein the source data received from a data source is stored and extracted in real-time.

13. The method of claim 11, wherein the source data received from a data source is structured in a generic format.

14. The method of claim 13, wherein the source data received from a data source is converted into the generic format.

15. The method of claim 11, wherein generating the plurality of tables includes:
generating tables for the attributes and parameters in an object model template corresponding to the source data selected for collection.

16. The method of claim 15, wherein generating the plurality of tables includes:
generating a root table based on the object model template, the root table being an aggregate class associating an object included in the object model template with attributes or parameters associated with the object.

17. The method of claim 15, wherein generating the plurality of tables includes receiving data selections from a user based on a catalog produced based on the object model template.

18. The method of claim 17, including:
assigning unique names to the tables and columns based on the object model template.

19. The method of claim 16, wherein the selected source data is stored based on prepared statements corresponding to the attributes and the parameters in the object model template.

20. The method of claim 18, wherein the selected source data is stored based on the prepared statements using batch inserts.
